(19) United States
(12) Patent Application Publication
(10) Pub. No.: US 2008/0229205 A1
(43) Pub. Date: Sep. 18, 2008

(54) METHOD OF PROVIDING METADATA ON PART OF VIDEO IMAGE, METHOD OF MANAGING THE PROVIDED METADATA AND APPARATUS USING THE METHODS

(75) Inventors: Woo-hyoung Lee, Yongin-si (KR); Eun Namgung, Suwon-si (KR); Do-jun Yang, Suwon-si (KR); Hyung-tak Choi, Suwon-si (KR); In-chul Hwang, Suwon-si (KR); Zhang-hoon Oh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/876,825

(22) Filed: Oct. 23, 2007

(30) Foreign Application Priority Data
Mar. 13, 2007 (KR) 10-2007-0024319

(51) Int. Cl. G06F 3/00

(52) U.S. Cl. 715/723

(57) ABSTRACT

Provided are a method and apparatus for providing metadata on parts of a video image, a method for managing the provided metadata and an apparatus using the methods. The terminal device includes a playback unit decoding an input video stream and reconstructing a video image, a display unit displaying the reconstructed video image, a user interface allowing a user to select a segment that is part of the reconstructed video image and receiving metadata regarding the selected segment, a metadata generator generating the received metadata in a structured document, and a network interface transmitting the generated structured document to a predetermined first server.

### CROSS-REFERENCE TO RELATED APPLICATION

1 This application claims priority from Korean Patent Application No. 10-2007-0024319 filed on Mar. 13, 2007 in the Korean Intellectual Property Office, the disclosure of which is incorporated herein by reference in its entirety.

### BACKGROUND OF THE INVENTION

1. Field of the Invention

The present invention relates to content searching, and, more particularly, to a method and apparatus allowing a user to access an arbitrary part of content using metadata provided by multiple users other than the user accessing the content.

2. Description of the Related Art

Over the past few years there has been a rapid proliferation of Internet Protocol Televisions (IP TVs). IP TV is a service in which a variety of information, moving image content, broadcasting services, and so on are provided through a television receiver over ultrahigh-speed Internet. IPTV, which incorporates both Internet and television (TV) services, is a type of digital convergence. However, IPTV is different from a conventional Internet TV in that a television receiver, rather than a computer monitor, is used and a remote control, rather than a mouse, is used. IPTV service can be utilized simply by connecting a television receiver, a set-top box, and an Internet channel. That is, a user has only to connect a set-top box or an exclusive modem to a television receiver, and to then apply power to turn on the television receiver, thereby initiating the IPTV service. Accordingly, even an inexperienced computer user is able to easily use Internet searching and a variety of content and interactive services such as movie viewing, music listening, home shopping, home banking, online gaming, and so on, simply using a remote controller.

In view of the ability to render broadcast content as well as video and audio, the IPTV service is substantially similar to general cable and satellite services. In contrast to standard distribution, cable broadcasting, and satellite broadcasting, one of the prominent features of IPTV is interactivity, thereby enabling users to selectively view only a desired program at a convenient time. The control or initiative in TV broadcasting is being transferred from broadcasting companies or providers to viewers. Currently, IPTV service is provided in many countries, including Hong Kong, Italy, Japan, and so on. However, IPTV is still in the seeding stage. In Korea, communication operators are taking advantage of existing infrastructures to offer users IPTV service.

In currently available IPTV services, users have to search for and view particular content using limited information, such as movie titles, thumbnail images, and the like. In addition, a user must employ a separate editor tool to extract parts from the content, such as where an actor (or actress) appears, which is burdensome. In conventional IPTV services, searching for content using only limited information may present several problems; the needs of users may not be satisfied, and the interactivity of IPTV may not be fully utilized.

Accordingly, there is a need to provide interactivity between users as well as interactivity between existing IPTV service providers and users.

### SUMMARY OF THE INVENTION

The present invention provides a method and apparatus allowing a user to access an arbitrary segment of digital broadcasting content using metadata provided by multiple users other than the user accessing the content.

The above and other objects of the present invention will be described in or be apparent from the following description of the preferred embodiments.

According to an aspect of the present invention, there is provided a terminal device including a playback unit decoding an input video stream and reconstructing a video image, a display unit displaying the reconstructed video image, a user interface allowing a user to select a segment that is part of the reconstructed video image and receiving metadata regarding the selected segment, a metadata generator generating the received metadata in a structured document, and a network interface transmitting the generated structured document to a predetermined first server.

According to another aspect of the present invention, there is provided a metadata management server including a network interface receiving metadata from a plurality of terminals regarding a segment that is part of a video image, a metadata processor sorting only valid metadata from the received metadata based on statistical information obtained from the plurality of terminals, a metadata storage unit storing the sorted metadata, and a search unit searching for the segment matching the keywords received from a first terminal and providing valid metadata regarding the searched segment to the first terminal.

According to still another aspect of the present invention, there is provided a method of providing metadata regarding part of a video image, the method including decoding an input video stream and reconstructing a video image, displaying the reconstructed video image, allowing a user to select a segment that is the part of the reconstructed video image and receiving metadata regarding the selected segment, generating the received metadata in a structured document, and transmitting the generated structured document to a predetermined first server.

According to a further aspect of the present invention, there is provided a method for managing metadata including receiving metadata from a plurality of terminals regarding a segment that is part of a video image, sorting only valid metadata from the received metadata based on statistical information obtained from the plurality of terminals, storing the sorted metadata, and searching for the segment matching the keywords received from a first terminal and providing valid metadata regarding the searched segment to the first terminal.

### BRIEF DESCRIPTION OF THE DRAWINGS

The above and other features and advantages of the present invention will become apparent by describing in detail preferred embodiments thereof with reference to the attached drawings in which:

FIG. 1 is a diagram showing an example of an overall system to which the present invention is applied;

FIG. 2 is a block diagram of a terminal device according to an embodiment of the present invention;

FIG. 3 illustrates an input screen of metadata according to an embodiment of the present invention;

FIG. 4 is a diagram showing an example of the metadata illustrated in FIG. 3 recorded in an XML document;

FIG. 5 is a block diagram of a metadata management server according to an embodiment of the present invention;

FIG. 6 is a diagram showing an example of a list of segments generated from the metadata of FIG. 4;

FIG. 7 is a diagram showing an example of a search result that a terminal device provides a user;

FIG. 8 is a block diagram of a content server according to an embodiment of the present invention;

FIG. 9 is a flowchart illustrating a method of a terminal device providing metadata according to an embodiment of the present invention; and

FIG. 10 is a flowchart illustrating a method of a metadata management server managing metadata according to an embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The embodiments are described below to explain the present invention by referring to the figures.

The present invention proposes a technique of allowing users to upload user-defined metadata (video tags or bookmarks) while viewing broadcast content and allowing other users to efficiently search for broadcast content using the uploaded metadata. In such a manner, multiple users can easily access particular broadcast content or a segment of the broadcast content in a more convenient way. In particular, a user can easily move to a desired scene in the broadcast content, e.g., a scene where a favorite character appears or a scene recommended by other users.

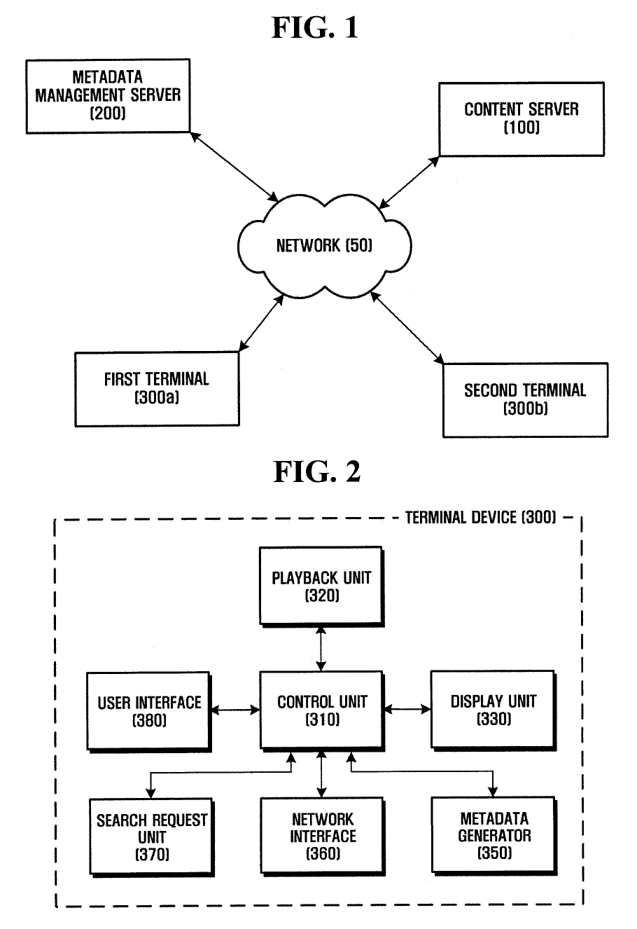

FIG. 1 is a diagram showing an example of an overall system to which the present invention is applied.

A network 50 has a content server 100, a metadata management server 200, and a plurality of terminals 300a and 300b connected thereto. The network 50 may be either the Internet or an intranet, and may be either a wired network or a wireless network.

The content server 100 delivers encoded content, e.g., a video stream encoded by a standard codec such as MPEG-4 or H.264 to terminals 300a and 300b. The terminals 300a and 300b receive the video stream, decode the received video stream, and display the user's desired video content.

Here, while viewing the video content, users of the terminals 300a and 300b select part of the video content (to be referred to as a “segment” hereinafter) and enter metadata regarding the segment. The metadata means information data regarding the segment entered in a tag form.

The entered metadata is automatically transmitted to the metadata management server 200. Then, the metadata management server 200 collects the metadata and sorts some of the collected metadata. Thereafter, upon a search request from the first terminal 300a, the metadata management server 200 provides metadata matching a keyword included in the search request to the first terminal 300a.

If the first terminal 300a selects a particular segment using the provided metadata, the content server 100 provides the first terminal 300a with the segment through a streaming service. Then, the first terminal 300a decodes the provided segment and displays the decoded segment for a user's viewing.

FIG. 2 is a block diagram of a terminal device (300) according to an embodiment of the present invention. The terminal device 300 includes a control unit 310, a playback unit 320, a display unit 330, a metadata generator 350, a network interface 360, a search request unit 370 and a user interface 380.

The control unit 310 is connected to other constituent elements of the terminal device 300 through a communication bus, and controls operations of the constituent elements. The control unit 310 may be called a central processing unit (CPU), a microprocessor, or a microcomputer.

The network interface 360 communicates with the metadata management server 200 or the content server 100 through the network 50. The network interface 360 sends a search request to the metadata management server 200, receives a response to the search request from the metadata management server 200, and receives a video stream from the content server 100.

The network interface 360 may be a wired interface under the Ethernet standard, an IEEE 802.11 wireless interface, or other various interfaces known in the art.

The playback unit 320 decodes the video stream provided from the content server 100 and received through the network interface 360. The decoding process may include a video-reconstruction process based on standards such as MPEG-4, H.264, and the like.

The display unit 330 displays the video image that is decoded by the playback unit 320 and reconstructed for viewing. To this end, the display unit 330 may include a video processor for converting the reconstructed video image using the NTSC (National Television System Committee method) or PAL (phase alternation line system) standard, a display device for displaying the converted video image, such as a PDP (Plasma Display Panel), an LCD (Liquid Crystal Display), a CRT (Cathode Ray Tube), a DMD (Digital Micromirror Device), or the like.

The user interface 380 is an interface that allows a user to issue commands to the terminal device 300. In order to receive the commands from the user, the user interface 380 can be implemented as various types of devices, e.g., an IR (infra-red) receiver receiving signals from a remote controller, a voice recognizer recognizing a user's voice, a keyboard interface, a mouse interface, or the like. The display unit 330 displays a screen for inputting a user's command and processing the results of the user's command.

While the playback unit 320 plays back a particular video stream, the user may select a segment of the video stream through the user interface 380 to enter metadata regarding the segment.

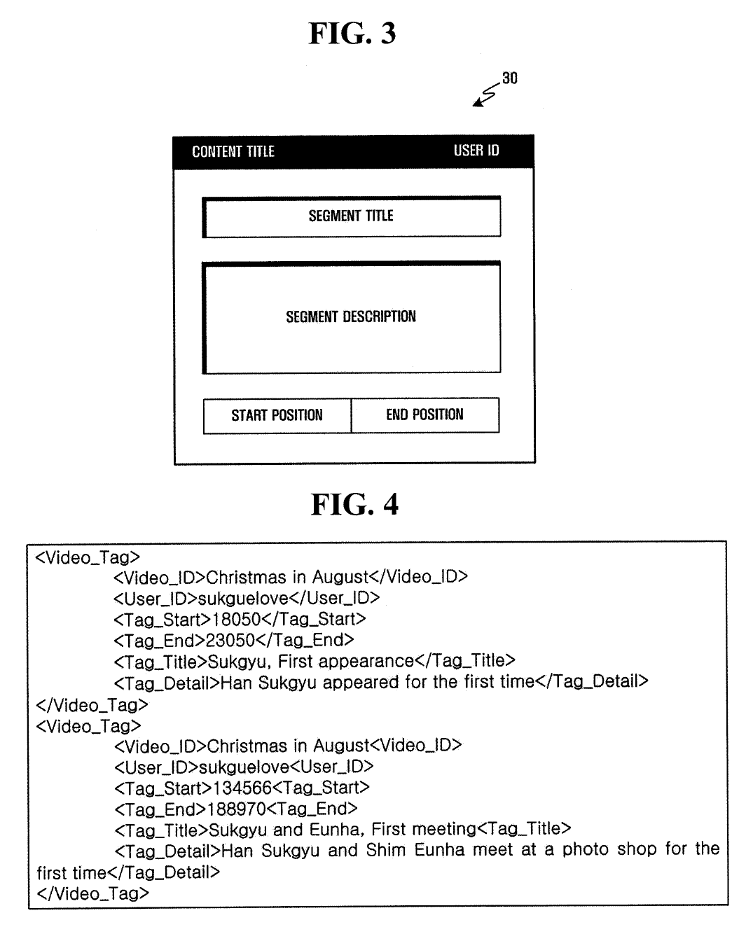

FIG. 3 illustrates an input screen (30) of metadata according to an embodiment of the present invention. The user may select a segment through the input screen 30 and enter metadata regarding a segment title, a segment description, and so on. A content title and a user ID may be displayed at an upper portion of the screen 30 as predefined data, rather than as input data. The user ID represents an identifier that can be set by the user for the terminal device 300, and the content title represents a title of the content, e.g., a video stream, that is currently being played back. In practical communication between the terminal device 300 and the metadata management server 200 or the content server 100, an intrinsic content identifier may be used instead of the content title.

The user may select a segment by directly entering numeric values representing a start position (a start time or a start frame number) and an end position (an end time or an end frame number). Alternatively, the user may select a segment simply by pressing a selection button twice while playing back content.

Based on the metadata input by the user, the metadata generator 350 generates a structured document in, e.g., XML (Extensible Markup Language), or HTML (Hyper-text Markup Language) format.

FIG. 4 is a diagram showing an example of the metadata illustrated in FIG. 3 recorded in an XML document. On the whole, metadata is recorded between <Video_Tag> and </Video_Tag>. The number of sets of <Video_Tag> and </Video_Tag> is equal to the number of segments the user intends to record in the XML document.

In detail, <Video_ID> is a tag for recording a content title or content ID, and <User_ID> is a tag for recording a user ID. <Tag_Start> and <Tag_End> are tags for recording a start frame number and an end frame number of a current segment, respectively. <Tag_Title> and <Tag_Detail> are tags for recording a segment title and a segment description, which are input by the user.

Eventually, the metadata generator 350 generates the structured document shown in FIG. 4 based on the user's input screen shown in FIG. 3 and transmits the generated document to the metadata management server 200 through the network interface 360.

The terminal device 300 provides the metadata management server 200 with the metadata regarding the segment, sends keywords input by the users of the terminal device 300 to the metadata management server 200, and receives search results. As described above, users can read metadata entered by other users and can selectively view a desired segment through the search results received in such a manner.

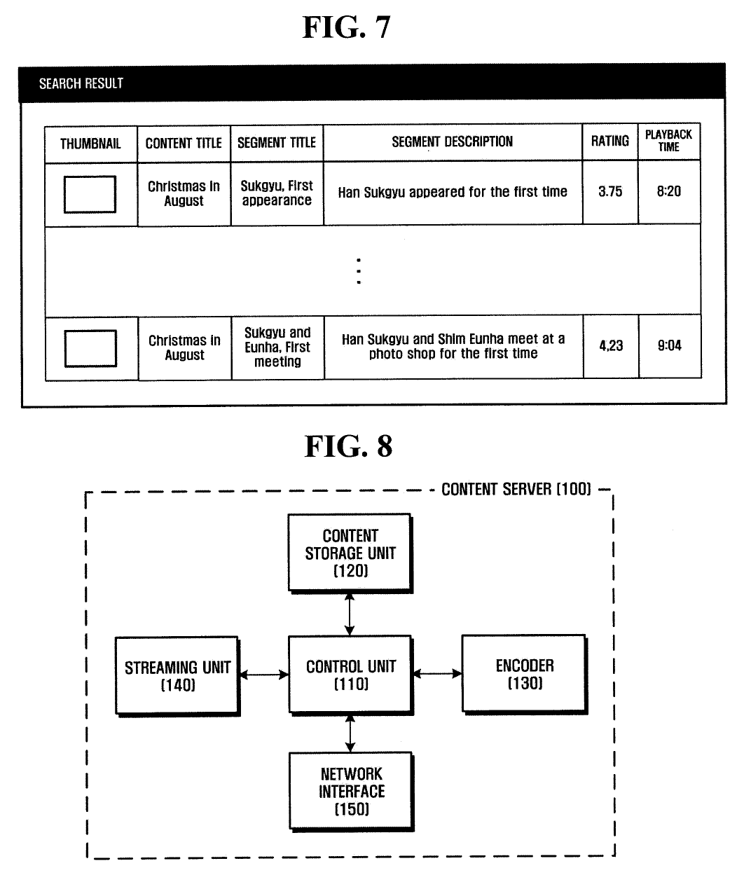

To this end, the search request unit 370 receives keywords input by the user through the user interface 380, sends the keywords to the metadata management server 200 through the network interface 360, and receives the search results from the metadata management server 200 through the network interface 360. The search results will later be described in more detail with reference to FIG. 7.

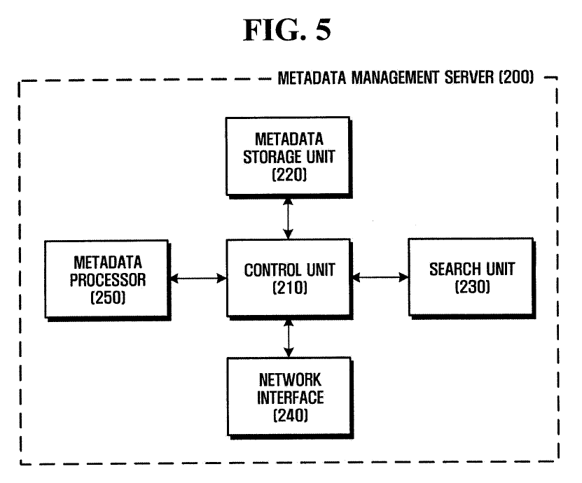

FIG. 5 is a block diagram of a metadata management server (200) according to an embodiment of the present invention.

The metadata management server 200 may include a control unit 210, a metadata storage unit 220, a search unit 230, a network interface 240 and a metadata processor 250.

The control unit 210 is connected to other constituent elements of the metadata management server 200 through a communication bus and controls the operations of the constituent elements.

The network interface 240 communicates with the terminal device 300 or the content server 100 through the network 50. In particular, the network interface 240 receives a search request from the terminal device 300 and sends the search result to the terminal device 300.

The metadata storage unit 220 receives structured documents generated based on the metadata from a plurality of terminals through the network interface 240, and collects and stores the metadata contained in the structured documents. The metadata storage unit 220 may be implemented as a nonvolatile memory device such as ROM, PROM, EPROM, EEPROM; a flash memory unit; a volatile memory device such as RAM; a storage medium such as a hard disk or an optical disk; or any other known storage medium.

The metadata processor 250 sorts the metadata stored in the metadata storage unit 220, and deletes invalid metadata from the metadata storage unit 220.

Since the users of the terminal device 300 freely enter the segment title and segment description, they may inadvertently enter the segment title and segment description incorrectly. In some cases, inappropriate terms may be contained in the segment title and segment description so that they cannot be shared with the public. Accordingly, it is necessary to sort the metadata provided from the plurality of terminals prior to collecting the metadata. The sorting process may be done manually by a manager of the metadata management server 200. However, it is impractical to manually sort large amounts of metadata provided from the plurality of terminals.

Thus, it is required that the users of the terminals themselves participate in the sorting process. For example, users viewing a segment using particular metadata are made to participate in rating the metadata. The metadata processor 200 may select only the metadata exceeding predetermined criteria as valid metadata, based on statistical information evaluated by many users, including rating marks, view counts, recommendation counts, and so on. As another example, metadata reported by more than a constant number of users may be selected as invalid metadata, and the remaining metadata may be selected as valid metadata. Thereafter, the metadata processor 250 deletes the invalid metadata from the metadata storage unit 220.

The search unit 230 searches for a search result matching the metadata stored in the metadata storage unit 220 using the keywords provided from the terminal device 300. The search unit 230 may perform searches using the keywords only in the segment title of the metadata, or in both the segment title and the segment description. In either case, the search unit 230 provides the terminal device 300 with the metadata regarding the segment matching the keywords as the search result.

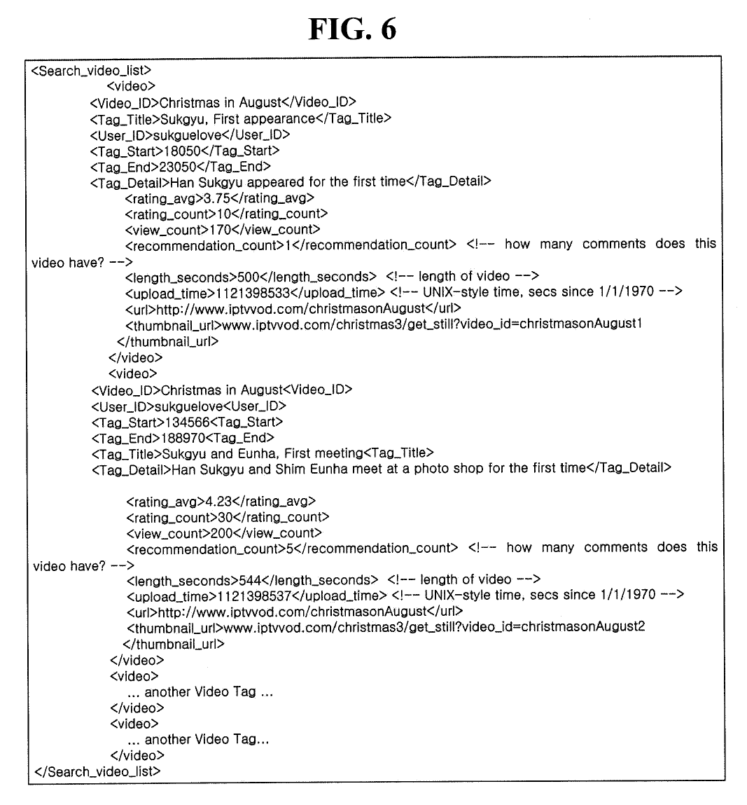

The metadata sorted by the metadata processor 250 may be stored in the metadata storage unit 220 in various types. For example, a list of segments in the form of XML, as shown in FIG. 6, may be stored in the metadata storage unit 220.

FIG. 6 is a diagram showing an example of a segment list generated from the metadata provided by the terminal device 300 in such a form as shown in FIG. 4.

The segment list contains metadata listed by segment, as shown in FIG. 4, statistical information, and additional information for the segment. The statistical information is obtained from multiple users, and the additional information is directly obtained from the corresponding segment.

The statistical information evaluated by many users may include an average of rating marks (rating_avg), view counts (view_count), recommendation counts (recommendation_count), and so on. The additional information may include a playback time of the corresponding segment (length_seconds), an upload time (upload_time), a Uniform Resource Locator (URL) of a representative home page, a thumbnail URL (thumbnail_url), and so on.

The search unit 230 extracts only the tag items of segments matching the keywords input by the user from the segment list shown in FIG. 6, and transmits the extracted tag items to the terminal device 300 through the network interface 240.

Then, the search request unit 370 of the terminal device 300 creates a search result screen using the transmitted tag items to be offered to the user, and the display unit 330 to displays the same. For example, it is assumed that the keyword is “Han Sukgyu”, a leading actor. FIG. 7 is a diagram showing an example of a search result with which the terminal device 300 provides a user. The search request unit 370 may display more tag items on the search result screen than those shown in FIG. 7.

If the user of the terminal device 300 selects a desired segment by referring to the search result screen shown in FIG. 7, the search request unit 370 makes a request to stream the segment to the content server 100. When making the request to stream the segment, information including a content title (or a content ID) of the content to which the segment belongs, a start position and an end position of the segment, and so on, is to be transmitted to the content server 100. The information contained in the tag items is to be transmitted from the search unit 230 of the metadata management server 200 to the terminal device 300.

The content server 100 streams the segment of the corresponding content to the terminal device 300 upon a request from the terminal device 300. FIG. 8 is a block diagram of a content server (100) according to an embodiment of the present invention. The content server 100 includes a control unit 110, content storage unit 120, an encoder 130, a streaming unit 140 and a network interface 150.

The control unit 110 is connected to other constituent elements of the content server 100 through a communication bus and controls operations of the constituent elements.

The network interface 150 communicates with the terminal device 300 or the content server 100 through the network 50. In particular, the network interface 150 receives a streaming request from the terminal device 300 and sends a segment according to the streaming request to the terminal device 300.

The content storage unit 120 stores various content sources and encoded content. The encoder 130 encodes the content sources stored in the content storage unit 120 using the standard codec such as MPEG-4, or H.264, generates encoded content, and sends the same back to the content storage unit 120 for storage.

The streaming unit 140 extracts only parts corresponding to the segment among the encoded content and streams the same to the terminal device 300 using RTP (Real-time Transport Protocol), or RTSP (Real-time Transport Streaming Protocol). The streaming unit 140 performs extraction using information regarding the start position and end position provided from the terminal device 300.

Finally, the network interface 360 of the terminal device 300 receives the segment streamed from the content server 100. The playback unit 320 plays back the received segment. The display unit 330 displays the played segment to the user.

The user may optionally perform ratings or recommendations on the segment at any time while viewing the segment. The rating or recommendation performed by the user is fed back to the metadata management server 200. The metadata management server 200 may update the segment list stored in the metadata storage unit 220 in real time, based on the rating or recommendation.

While the content server 100 and the metadata management server 200 have been described as independent devices, they may be implemented as a combined device.

The type of each of the various components shown in FIGS. 2, 5 and 8 may be, but is not limited to, a software or hardware component, such as a Field Programmable Gate Array (FPGA) or an Application Specific Integrated Circuit (ASIC), which performs certain tasks. A module may advantageously be configured to reside on the addressable storage medium and to execute on one or more processors. The functionality provided for in the components and modules may be combined into fewer components and modules or further separated into additional components and modules. In addition, the components and modules may be implemented such that they execute on one or more computers.

In addition, each block may represent a module, a segment, or a portion of code, which may comprise one or more executable instructions for implementing the specified logical functions. It should also be noted that in other implementations, the functions noted in the blocks may occur out of the order noted or in different configurations of hardware and software. For example, two blocks shown in succession may, in fact, be executed substantially concurrently, or the blocks may sometimes be executed in reverse order, depending on the functionality involved.

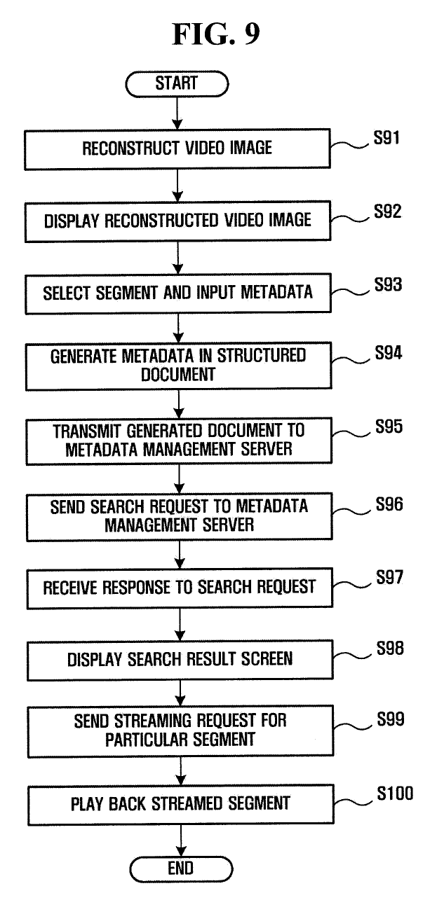

FIG. 9 is a flowchart illustrating a method of a terminal device (300) providing metadata according to an embodiment of the present invention.

Referring to FIGS. 2 and 9, the playback unit 320 decodes an input video stream and reconstructs a video image in operation S91. The display unit 330 displays the reconstructed video image to the user in operation S92. In operation S93, the user selects part of the reconstructed video image, i.e., a segment, through the user interface 380 and inputs metadata regarding the selected segment. Here, in order to select the segment, the user enters a start position and an end position of the video image. The metadata includes a segment title, a segment description, and so on. In operation S94, the metadata generator 350 generates a structured document containing the entered metadata. The structured document may be generated in various forms. However, in the present invention, the structured document is generated in an XML document by way of example, as shown in FIG. 4. In operation S95, the network interface 360 transmits the generated document to the metadata management server 200. The providing of the metadata from the terminal device 300 to the metadata management server 200 is completed through the above-described procedure.

In addition, the procedure of the terminal device 300 searching for the segment based on the metadata provided from the metadata management server 200 is described in the following:

In operation S96, the search request unit 370 sends a search request by sending keywords input by the user to the metadata management server 200 to make a request for metadata regarding the segment matching the keywords. Thereafter, the search request unit 370 receives a response to the search request from the metadata management server 200 through the network interface 360 in operation S97.

In operation S98, the display unit 330 displays a search result screen to the user, based on the received response. An example of the search result screen is shown in FIG. 7.

In operation S99, the search request unit 370 sends a streaming request for a particular segment to the content server 100 through the search result screen. The streaming request includes an identifier for the video content to which the segment belongs, a start position and an end position of the segment, and so on.

Finally, in operation S100, the playback unit 320 plays back the segment streamed from the content server 100, upon the streaming request.

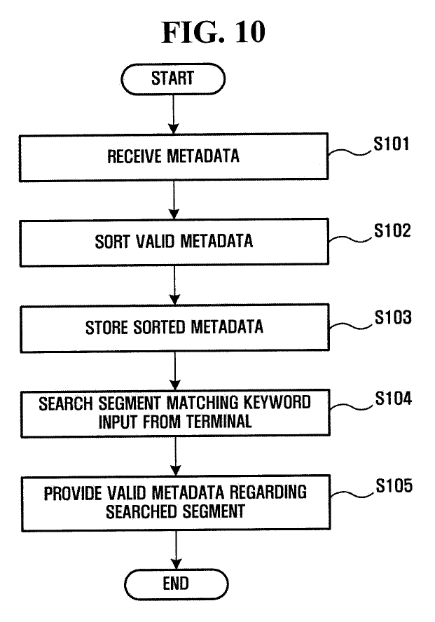

FIG. 10 is a flowchart illustrating a method of a metadata management server (200) managing metadata according to an embodiment of the present invention.

Referring to FIGS. 5 and 10, in operation S101, the network interface 240 receives metadata regarding a segment of a video image received from a plurality of terminals.

In operation S102, the metadata processor 250 sorts only valid metadata from the received metadata based on the statistical information obtained from the plurality of terminals. The statistical information may include at least one of rating marks evaluated by the user of the terminal device 300, view counts, recommendation counts, evaluation counts, and so on.

In operation S103, the metadata storage unit 220 stores the sorted metadata. Here, the metadata storage unit 220 preferably stores the sorted metadata in a structured document, e.g., an XML document. As shown in FIG. 6, the metadata listed by segment, statistical information, and additional information for the segment may be contained in the structured document. The additional information may include a playback time of the corresponding segment, an uploading time, a thumbnail URL, and so on.

In operation S104, the search unit 230 searches for segments matching the keywords input from a first terminal among the plurality of terminals. Valid metadata regarding the searched segments is provided to the first terminal in operation S105.

As described above, according to the present invention, a video tag or bookmark created by a user provided with content from an IPTV can be uploaded to a server. In addition, the video tag or bookmark created by the user can be exploited when other users search for content. That is, apart from the capability to appreciate particular content, according to the present invention, users are able to share their evaluation and/or opinion about the particular content with others. Further, the present invention can advantageously activate IPTV industry business.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A terminal device comprising:
a playback unit decoding an input video stream and reconstructing a video image;
a display unit displaying the reconstructed video image;
a user interface allowing a user to select a segment that is part of the reconstructed video image and receiving metadata regarding the selected segment;
a metadata generator generating the received metadata in a structured document; and
a network interface transmitting the generated structured document to a predetermined first server.

2. The terminal device of claim 1, wherein the first server further comprises a search request unit receiving keywords input from the user to make a request for metadata regarding segment matching the keywords.

3. The terminal device of claim 1, wherein the segment is selected by receiving information about a start position and an end position in the video image from the user.

4. The terminal device of claim 1, wherein the metadata regarding the segment includes a segment title and a segment description.

5. The terminal device of claim 1, wherein the structured document is an XML (Extensible Markup Language) document.

6. The terminal device of claim 2, wherein the search request unit receives a response to the search request from the first server, and the display unit displays a search result screen to the user based on the received response.

7. The terminal device of claim 6, wherein the search request unit sends a second server a streaming request for the segment selected by the user through the search result screen, and the playback unit plays back the segment streamed from the second server upon the streaming request.

8. A metadata management server comprising:
a network interface receiving metadata, regarding a segment that is part of a video image, from a plurality of terminals;
a metadata processor sorting only valid metadata from the received metadata based on statistical information obtained from the plurality of terminals;
a metadata storage unit storing the sorted metadata; and
a search unit searching for the segment matching the keywords received from a first terminal and providing valid metadata regarding the searched segment to the first terminal.

9. The metadata management server of claim 8, wherein the statistical information includes at least one of rating marks, view counts, recommendation counts, and evaluation counts.

10. The metadata management server of claim 8, wherein the metadata storage unit stores the sorted metadata in the form of a structured document.

11. The metadata management server of claim 8, wherein the structured document is an XML (Extensible Markup Language) document and contains metadata listed by segment, statistical information and additional information for the segment.

12. The metadata management server of claim 11, wherein the additional information may include a playback time of the corresponding segment, an uploading time, and a thumbnail URL.

13. A method of providing metadata regarding part of a video image, the method comprising:
decoding an input video stream and reconstructing a video image;
displaying the reconstructed video image;
allowing a user to select a segment that is the part of the reconstructed video image and receiving metadata regarding the selected segment;
generating the received metadata in a structured document; and
transmitting the generated structured document to a predetermined first server.

14. The method of claim 13, wherein the transmitting of the generated structured document to the first server further comprises receiving keywords input by the user, for making a request for metadata regarding a segment matching the keywords.

15. The method of claim 13, wherein the segment is selected by receiving information about a start position and an end position in the video image from the user.

16. The method of claim 13, wherein the metadata regarding the segment includes a segment title and a segment description.

17. The method of claim 13, wherein the structured document is an XML (Extensible Markup Language) document.

18. The method of claim 14, further comprising:
receiving a response to the search request from the first server; and
displaying a search result screen to the user based on the received response.

19. The method of claim 19, further comprising:
sending a second server a streaming request for the segment selected by the user through the search result screen; and
playing back the segment streamed from the second server upon the streaming request.

20. A method of managing metadata, comprising:
receiving metadata regarding a segment, that is part of a video image received, from a plurality of terminals;
sorting only valid metadata from the received metadata based on statistical information obtained from the plurality of terminals;
storing the sorted metadata; and
searching for the segment matching the keywords received from a first terminal and providing valid metadata regarding the searched segment to the first terminal.

21. The method of claim 20, wherein the statistical information includes at least one of rating marks, view counts, recommendation counts, and evaluation counts.

22. The method of claim 20, wherein the storing of the metadata comprises storing the sorted metadata in the form of a structured document.

23. The method of claim 20, wherein the structured document is an XML (Extensible Markup Language) document and contains metadata listed by segment, statistical information and additional information for the segment.

24. The method of claim 23, wherein the additional information may include a playback time of the corresponding segment, an uploading time, and a thumbnail URL.
